(19) United States
(12) Patent Application Publication
(10) Pub. No.: US 2013/0293592 A1
(43) Pub. Date: Nov. 7, 2013

(54) 3D DISPLAY APPARATUS AND 3D DISPLAY SYSTEM AND DRIVING METHOD THEREOF

(71) Applicants: Chengliang Ye, Shenzhen (CN); Chia-Chiang Lin, Shenzhen (CN); Hung-Lung Hou, Shenzhen (CN)

(72) Inventors: Chengliang Ye, Shenzhen (CN); Chia-Chiang Lin, Shenzhen (CN); Hung-Lung Hou, Shenzhen (CN)

(73) Assignee: SHENZHEN CHINA STAR OPTOELECTRONICS TECHNOLOGY CO, LTD., Shenzhen (CN)

(21) Appl. No.: 13/522,699

(22) PCT Filed: May 14, 2012
(86) PCT No.: PCT/CN12/75423

§ 371 Date: Jul. 17, 2012

(30) Foreign Application Priority Data
May 3, 2012 (CN) 201210134469.5

(51) Int. Cl. G09G 5/10

(52) U.S. Cl. 345/690

(57) ABSTRACT

The present invention provides a 3D display apparatus, a 3D display system and a driving method thereof. The 3D display system comprises 3D display glasses and the 3D display apparatus. The 3D display apparatus comprises a liquid crystal display panel and a backlight module. In the driving method, when driving the liquid crystal display panel, the backlight module is turned on at least two times within a frame time. The present invention can improve a crosstalk problem and a flickering problem of the 3D display apparatus.

### FIELD OF THE INVENTION

The present invention relates to a display apparatus, a system and a driving method thereof for displaying three-dimensional (3D) images, and more particularly to a 3D display apparatus, a 3D display system and a driving method thereof using an active-shutter 3D display technology.

### BACKGROUND OF THE INVENTION

Liquid crystal displays (LCDs) have been widely applied in electrical products. Currently, most of LCDs are backlight type LCDs which include a liquid crystal panel and a backlight module, wherein a 3D display technology has been one of important technologies of the LCDs.

At present, in an active-shutter 3D display technology, a 3D image effect is achieved by raising a refresh rate of frames and in cooperation with a fast switch of 3D glasses, such that a viewer's eyes can view right and left images correspondingly to form a stereoscopic image effect.

However, in the active-shutter 3D display technology, it is generally required to use a liquid crystal material with a high-speed response, or to increase regions for local dimming the backlight module, so as to improve a crosstalk problem, and the cost of the above-mentioned methods is very high. Another method for improving the crosstalk problem is to extend a duration time of each frame. However, when extending the frame time, user's eyes are likely to feel a flicker phenomenon of the display.

As a result, it is necessary to provide 3D display apparatus, a 3D display system and a driving method thereof to solve the problems existing in the conventional technologies, as described above.

### SUMMARY OF THE INVENTION

The present invention provides a 3D display apparatus, a 3D display system and a driving method thereof, so as to improve the crosstalk problem and a flickering problem of the conventional 3D display.

A primary object of the present invention is to provide a driving method of a 3D display apparatus, and the driving method comprises: utilizing a display refresh rate to drive a liquid crystal display panel; and when driving the liquid crystal display panel, turning on a backlight module at least two times within a frame time.

In one embodiment of the present invention, the display refresh rate is equal to or lower than 120 Hz.

In one embodiment of the present invention, the display refresh rate is in the range of 60 Hz to 120 Hz.

In one embodiment of the present invention, the frame time is equal to or less than 20 ms.

In one embodiment of the present invention, the frame time is in the range of 8 ms to 20 ms.

In one embodiment of the present invention, when turning on the backlight module, a brightness of the backlight module is reduced.

In one embodiment of the present invention, when turning on the backlight module, a backlight signal is utilized to turn on the backlight module, and the backlight signal has a first pulse and a second pulse, and the first pulse is formed prior to the second pulse.

In one embodiment of the present invention, a width of the first pulse is less than a width of the second pulse.

In one embodiment of the present invention, a width of the first pulse is greater than a width of the second pulse.

In one embodiment of the present invention, when turning on the backlight module, a backlight signal is utilized to turn on the backlight module, and the backlight signal has a first pulse, a second pulse and a third pulse in sequence.

Another object of the present invention is to provide a 3D display apparatus, and the 3D display apparatus comprises: a liquid crystal display panel; and a backlight module, wherein, when driving the liquid crystal display panel, the backlight module is turned on at least two times within a frame time.

In one embodiment of the present invention, the display refresh rate is in the range of 60 Hz to 120 Hz.

In one embodiment of the present invention, the frame time is in the range of 8 ms to 20 ms.

In one embodiment of the present invention, when turning on the backlight module, a brightness of the backlight module is reduced.

In one embodiment of the present invention, when turning on the backlight module, a backlight signal is utilized to turn on the backlight module, and the backlight signal has a first pulse and a second pulse, and the first pulse is formed prior to the second pulse.

Still another object of the present invention is to provide a 3D display system, and the 3D display system comprises: 3D display glasses; and a 3D display apparatus. The 3D display apparatus comprises: a liquid crystal display panel; and a backlight module, wherein, when driving the liquid crystal display panel, the backlight module is turned on at least two times within a frame time.

In one embodiment of the present invention, the display refresh rate is in the range of 60 Hz to 120 Hz.

In one embodiment of the present invention, the frame time is in the range of 8 ms to 20 ms.

In one embodiment of the present invention, when turning on the backlight module, a brightness of the backlight module is reduced.

In one embodiment of the present invention, when turning on the backlight module, a backlight signal is utilized to turn on the backlight module, and the backlight signal has a first pulse and a second pulse, and the first pulse is formed prior to the second pulse.

In comparison with the crosstalk problem existing in the conventional 3D display, with the use of the 3D display apparatus, the 3D display system of the present invention and the driving method thereof, the display refresh rate of the LCD panel can be reduced to improve the crosstalk problem of the 3D display apparatus. Meanwhile, the backlight module can be turned on at least two times within the frame time, thereby improving the flickering problem.

The structure and the technical means adopted by the present invention to achieve the above-mentioned and other objects can be best understood by referring to the following detailed description of the preferred embodiments and the accompanying drawings.

### DESCRIPTION OF THE DRAWINGS

FIG. 1 is a schematic diagram showing a 3D display system according to an embodiment of the present invention;

FIG. 2 is a schematic diagram showing a backlight signal of the backlight module according to an embodiment of the present invention;

FIG. 3 is a graph showing a relation between a light intensity and a time of the backlight module according to the present invention; and

FIG. 4 is a schematic diagram showing a backlight signal of the backlight module according to another embodiment of the present invention.

### DETAILED DESCRIPTION OF THE PREFERRED EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, structure-like elements are labeled with like reference numerals.

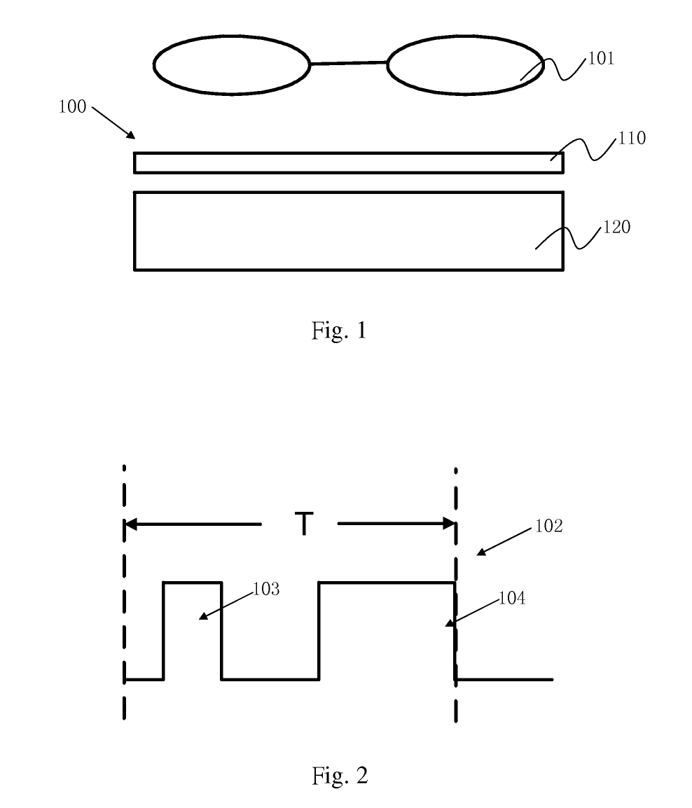

Referring to FIG. 1, a schematic diagram showing a 3D display system according to an embodiment of the present invention is illustrated. The 3D display system of the present embodiment comprises a 3D display apparatus 100 and 3D display glasses 101. The 3D display apparatus is capable of displaying 3D images. When a user views the 3D images displayed by the 3D display apparatus 100, the 3D display glasses 101 is required to view the 3D images. The 3D display apparatus 100 can comprise a liquid crystal display (LCD) panel 110 and a backlight module 120. The LCD panel 110 is disposed opposite to the backlight module 120, and the backlight module 120 may be realized as a side lighting backlight module or a bottom lighting backlight module to provide the LCD panel 110 with the back-light. In the 3D display apparatus 100 of the present embodiment, when driving the LCD panel 110, the backlight module 120 is turned on at least two times within a duration time of each frame (a left or right eye frame).

The driving method of the 3D display apparatus 100 of the present invention can comprise the following steps: utilizing a display refresh rate to drive the liquid crystal display panel 110; and when driving the liquid crystal display panel 110, turning on the backlight module 120 at least two times within a frame time T.

When using the 3D display apparatus 100 to display the 3D images, the LCD panel 110 can continuously display left and right eye frames in sequence. At this time, the liquid crystal display panel 110 is refreshed according to the display refresh rate (or refresh frequency), and meanwhile, the 3D display glasses 101 is refreshed according to a glass refresh rate. In this case, the display refresh rate of the LCD panel 110 can be similar to the glass refresh rate of the 3D display glasses 101. In the present embodiment, the display refresh rate of the LCD panel 110 is preferably equal to or lower than 120 Hz, such as in the range of 60 Hz to 120 Hz. Similarly, the glass refresh rate of the 3D display glasses 101 is preferably equal to or lower than 120 Hz. That is, a single glass refresh rate of each glass of the 3D display glasses 101 is equal to or lower than 60 Hz.

When driving the LCD panel 110, the user can experience a stereoscopic image effect by the alternately overlapping of the left and right eye frames of the LCD panel 110 and the corresponding switch of the 3D display glasses 101. The display refresh rate of the LCD panel 110 can be lower than 120 Hz, thereby increasing a frame time of each frame (a left or right eye frame). That is, a time for rotating liquid crystal molecules of the LCD panel 110 in each frame is increased, such that the time is sufficient to rotate the liquid crystal molecules of the LCD panel 110 in each frame. Therefore, the LCD panel 110 can have a target brightness within a predetermined time, thereby improving the crosstalk problem of the 3D display apparatus 100. In this case, the frame time of each frame displayed by the LCD panel 110 is equal to or less than 20 ms, preferably in the range of 8 ms to 20 ms, such as 16.6 ms.

Referring to FIG. 2, a schematic diagram showing a backlight signal of the backlight module according to an embodiment of the present invention is illustrated. In this embodiment, when turning on the backlight module 120, the backlight signal 102 is utilized to turn on the backlight module 120. The backlight signal 102 may be a scan signal for turning on the backlight module 120 in a scanning manner. In the frame time T, the backlight signal 102 can have a first pulse 103 and a second pulse 104, and the first pulse 103 is formed prior to the second pulse 104, and a width of the first pulse 103 is less than a width of the second pulse 104. In one embodiment, the first pulse 103 can start at the first micro-second˜the third micro-second in the frame time T, and the second pulse 104 can start at the eighth micro-second˜the tenth micro-second in the frame time T, and the second pulse 104 can terminate at the end of the frame time T. Therefore, with the use of the backlight signal 102, the backlight module 120 can be turned on two times within the frame time T, wherein the second turn-on duration may be longer than the first turn-on duration, so as to improve the crosstalk problem. Certainly, in other embodiments, the width of the first pulse 103 can be greater than the width of the second pulse 104 for improving the crosstalk problem.

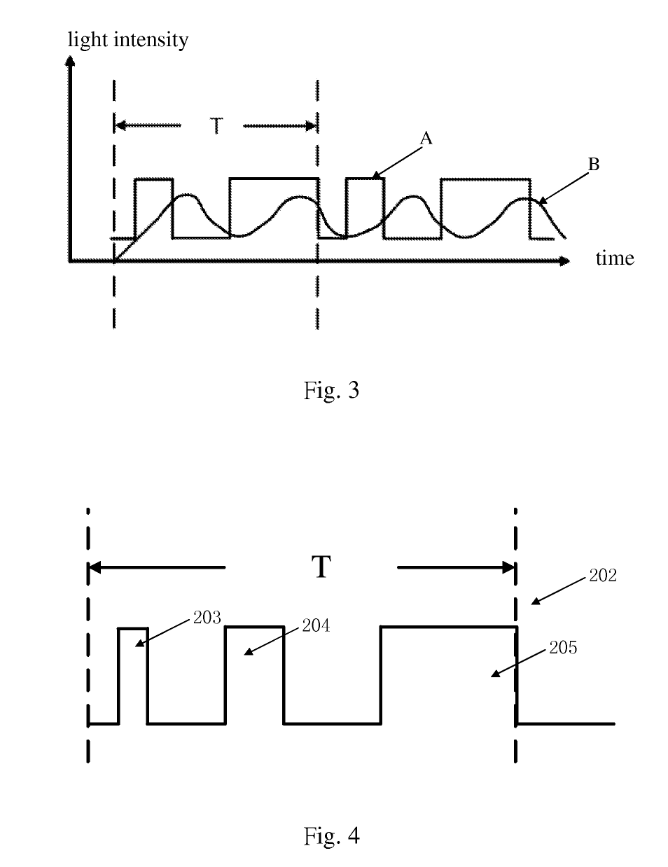

Referring to FIG. 3, a graph showing a relation between a light intensity and a time of the backlight module according to the present invention is illustrated. As shown in FIG. 3, a curve A indicates the relation between the light intensity and the time of the backlight module 120, and another curve B indicates a visual response of the user's eyes. Referring to FIG. 2, in the frame time T, the light intensity of the backlight module 120 is divided into the two turn-on durations, thereby reducing a brightness variation perceived by the user's eyes, so as to prevent that the visual response of the user's eyes only occurs in one turn-on duration, i.e. to prevent the user's eyes from perceiving the flickering of the display. In this case, in each of the turn-on durations, the brightness of the backlight module 120 can be reduced for further improving the crosstalk problem.

Therefore, with the use of the 3D display apparatus and the driving method thereof, the display refresh rate of the LCD panel 110 can be reduced, such that the LCD panel 110 can have a sufficient time to rotate the liquid crystal molecules in each frame for achieving the target brightness. Thus, the crosstalk problem of the 3D display apparatus 100 can be mitigated. Meanwhile, the backlight module 120 can be turned on at least two times within the frame time T, thereby preventing the user's eyes from perceiving the display flickering, as well as enhancing an image quality of the 3D display apparatus.

Referring to FIG. 4, a schematic diagram showing a backlight signal of the backlight module according to another embodiment of the present invention is illustrated. In this embodiment, the backlight module 120 can be turned on three times within the frame time T. At this time, a backlight signal 202 is utilized to turn on the backlight module 120. In the frame time T, the backlight signal 202 can have a first pulse 203, a second pulse 204 and a third pulse 205 in sequence. The width of the first pulse 203 and the second pulse 204 is preferably less than the width of the third pulse 205. The first pulse 203 can start at the first micro-second˜the third micro-second in the frame time T, and the third pulse 205 can terminate at the end of the frame time T. Therefore, with the use of the backlight signal 202, the backlight module 120 can be turned on three times within the frame time T, thereby preventing the user's eyes from perceiving the display flickering, as well as enhancing an image quality of the 3D display apparatus.

As described above, in the 3D display apparatus, the 3D display system and the driving method thereof, the display refresh rate of the LCD panel can be reduced to improve the crosstalk problem of the 3D display apparatus. Meanwhile, the backlight module can be turned on at least two times within the frame time, thereby improving the flickering problem.

The present invention has been described above with a preferred embodiment thereof, and it is understood that many changes and modifications to the described embodiment can be carried out without departing from the scope and the spirit of the invention that is intended to be limited only by the appended claims.

1. A driving method of a 3D display apparatus, comprising:
utilizing a display refresh rate to drive a liquid crystal display panel; and
when driving the liquid crystal display panel, turning on a backlight module at least two times within a frame time.

2. The driving method according to claim 1, wherein the display refresh rate is equal to or lower than 120 Hz.

3. The driving method according to claim 2, wherein the display refresh rate is in the range of 60 Hz to 120 Hz.

4. The driving method according to claim 1, wherein the frame time is equal to or less than 20 ms.

5. The driving method according to claim 4, wherein the frame time is in the range of 8 ms to 20 ms.

6. The driving method according to claim 1, wherein, when turning on the backlight module, a brightness of the backlight module is reduced.

7. The driving method according to claim 1, wherein, when turning on the backlight module, a backlight signal is utilized to turn on the backlight module, and the backlight signal has a first pulse and a second pulse, and the first pulse is formed prior to the second pulse.

8. The driving method according to claim 6, wherein a width of the first pulse is less than a width of the second pulse.

9. The driving method according to claim 6, wherein a width of the first pulse is greater than a width of the second pulse.

10. The driving method according to claim 1, wherein, when turning on the backlight module, a backlight signal is utilized to turn on the backlight module, and the backlight signal has a first pulse, a second pulse and a third pulse in sequence.

11. A 3D display apparatus, comprising:
a liquid crystal display panel; and
a backlight module, wherein, when driving the liquid crystal display panel, the backlight module is turned on at least two times within a frame time.

12. The 3D display apparatus according to claim 11, wherein the display refresh rate is in the range of 60 Hz to 120 Hz.

13. The 3D display apparatus according to claim 11, wherein the frame time is in the range of 8 ms to 20 ms.

14. The 3D display apparatus according to claim 11, wherein, when turning on the backlight module, a brightness of the backlight module is reduced.

15. The 3D display apparatus according to claim 11, wherein, when turning on the backlight module, a backlight signal is utilized to turn on the backlight module, and the backlight signal has a first pulse and a second pulse, and the first pulse is formed prior to the second pulse.

16. A 3D display system, comprising:
3D display glasses; and
a 3D display apparatus comprising:
a liquid crystal display panel; and
a backlight module, wherein, when driving the liquid crystal display panel, the backlight module is turned on at least two times within a frame time.

17. The 3D display system according to claim 16, wherein the display refresh rate is in the range of 60 Hz to 120 Hz.

18. The 3D display system according to claim 16, wherein the frame time is in the range of 8 ms to 20 ms.

19. The 3D display system according to claim 16, wherein, when turning on the backlight module, a brightness of the backlight module is reduced.

20. The 3D display system according to claim 16, wherein, when turning on the backlight module, a backlight signal is utilized to turn on the backlight module, and the backlight signal has a first pulse and a second pulse, and the first pulse is formed prior to the second pulse.
